(19) United States
(12) Patent Application Publication
(10) Pub. No.: US 2010/0276634 A1
(43) Pub. Date: Nov. 4, 2010

(54) USE OF THE FLASH SINTERING TECHNIQUE FOR THE SYNTHESIS AND DENSIFICATION OF IODOAPATITES

(76) Inventors: Lionel Campayo, Bagnols Sur Ceze (FR); Sophie Le Gallet, Dijon (FR); Florence Bart, Orsan (FR); Frédéric Bernard, Neuilly Les Dijon (FR); Yuri Grin, Dresden (DE)

Correspondence Address: MILES & STOCKBRIDGE PC, 1751 PINNACLE DRIVE, SUITE 500, MCLEAN, VA, 22102-3833, US

(21) Appl. No.: 12/681,772

(22) PCT Filed: Oct. 7, 2008
(86) PCT No.: PCT/EP08/63392

§ 371 Date: Jul. 21, 2010

(30) Foreign Application Priority Data
Oct. 8, 2007 (FR) 07 58128

(51) Int. Cl. C09K 3/00

(52) U.S. Cl. 252/182.33

(57) ABSTRACT

The invention relates to the use of the technique known as “flash sintering” for the synthesis and densification of iodine apatites or iodoapatites.

Applications: reprocessing of spent nuclear fuels in order to condition and store, in an apatite, the radioactive iodine present in the aqueous effluents from this reprocessing and, in particular, iodine-129.

### TECHNICAL FIELD

The present invention relates to the use of the technique referred to as “flash sintering”, also known under the acronyms SPS (Spark Plasma Sintering) and FAST (Field-Activated Sintering Technique) for the synthesis and densification of iodine apatites or iodoapatites.

This invention especially finds an application in the field of the reprocessing of spent nuclear fuels where it is capable of being used for conditioning and storing, in an apatite, the radioactive iodine present in the aqueous effluents produced during this reprocessing and, in particular, iodine-129.

### PRIOR ART

Iodine is a fission product present in spent nuclear fuels, the 129 isotope of which has a half-life of 15.7 million years.

Considering its radiotoxicity for man, which is closely linked to its affinity for the thyroid gland in which it concentrates, a certain number of studies have been carried out during recent years on the conditioning and storage of iodine in a durable matrix that withstands dissemination by vectors such as water.

Studies have shown that it is possible to incorporate iodine within a ceramic belonging to the family of apatites.

Iodoapatites may especially be synthesized by reaction between lead iodide (PbI₂) and a lead phosphovanadate of formula Pb₃(VO₄)_{1.6}(PO₄)_{0.4} (WO-A-96/18196 [1]) according to the reaction:

3Pb₃(VO₄)_{1.6}(PO₄)_{0.4}+PbI₂→Pb₁₀(VO₄)_{4.8}(PO₄)_{1.2}I₂.

This synthesis may be carried out in a sealed quartz ampoule for temperatures of the order of 700° C. and hold times of about ten hours, or else via a ceramic route, that is to say by reactive sintering under pressure (C. Guy et al., C. R. Physique 2002, 3, 827-837 [2]; E. R. Maddrell and P. K. Abraitis, Material Research Society Symposium Proceedings 2004, 807, 261-266 [3]).

In the latter case, added to the reactants is a third material, the role of which is to enable an impermeable containment of the iodine and the nature of which varies depending on the sintering technique chosen.

Thus, in the case of a reactive sintering under a uniaxial pressure or HUP (Hot Uniaxial Pressing), it is one of the reactants, in this particular case lead phosphovanadate, which may be used as a matrix [F. Audubert et al., Solid State Ionics 1997, 95(1-2), 113-119 [4]). This makes it possible to limit the diffusion of lead iodide above the melting point of the latter (410° C.). The matrix then serves not only to contain the iodine but also as a consumable reservoir for the formation of the iodoapatite.

In the case of a reactive sintering under isostatic pressure or HIP (Hot Isostatic Pressing), containers of various natures (metal, glass, etc.) may be used.

In all cases, the production of an iodoapatite requires temperatures above 500° C., for which temperatures a volatilization of the iodine would be observed in the absence of impermeable containment. Indeed, in the case of an apatite of composition Pb₁₀(VO₄)_{4.8}(PO₄)_{1.2}I₂, the start of mass loss, as determined by thermogravimetric analysis, corresponds to 500° C.

Moreover, reactive sintering can entail a certain number of difficulties. Indeed, achieving a reaction yield close to 100% while guaranteeing a high degree of densification, that is to say greater than 92%, proves to be complex. However, these two conditions must be met if it is desired to minimize the amounts of iodine capable of being released subsequently via leaching by the iodine apatites during the storage thereof in deep geological layer type sites.

In the case of a HUP reactive sintering, the optimization of the sintering conditions makes it possible to produce cer-cer composites which incorporate iodine with a weight content of 2.7% within an iodoapatite core having a degree of densification of 88%. For these values, a fraction of open porosity remains in the material, which results in the development of a surface favourable to the mobilization of the iodine by a potential vector (in the conservative assumption where the matrix does not provide any role of retention with respect to the dissemination of the iodine).

To avoid the pitfall of reactive sintering, the dissociation of the synthesis and sintering steps has been envisioned (M. UNO et al., Journal of Nuclear Materials 2001, 294(1-2), 119-122 [5]). However, in this case, there is a total of two high-temperature steps, which is energetically penalizing. Moreover, the management of the chamber assigned to the synthesis, which is then contaminated with iodine, puts a considerable burden on the process, both in terms of time and costs.

It turns out that, within the context of their work, the inventors have observed that the use of the flash sintering technique for synthesizing and densifying iodoapatites, instead of the conventional sintering techniques of HUP or HIP type, makes it possible, surprisingly, to solve all the problems mentioned above.

In particular, they have observed that the use of the flash sintering technique makes it possible to simultaneously obtain iodoapatites that have degrees of densification greater than 97% for reaction yields of 100% or close to this value, and to do away with the need to use a matrix intended for ensuring an impermeable containment of the iodine.

It is on these observations that the present invention is based.

### SUMMARY OF THE INVENTION

One subject of the invention is therefore the use of the flash sintering technique for the synthesis and densification of an iodoapatite.

It is recalled that the literature understands the expression “flash sintering” to mean a sintering in which the material to be densified is subjected to a uniaxial pressure in a die such as in a HUP sintering, but in which the die, which is constituted of an electrically conductive material (typically graphite), is passed through by an electric current, generally a pulsed direct current. This die therefore acts as a heat source, hence a high heating rate and a good transfer of this heat to the material to be densified.

As a result, at equivalent degrees of densification, this sintering technique makes it possible, as a general rule, to use sintering temperatures and times below those required by the conventional sintering techniques.

The invention may relate to the synthesis and densification of any type of iodoapatite. Thus, for example, it may apply to the preparation of the following iodoapatites:
Ca₁₀(VO₄)₆I₂ as described by A. Ditte in Annales de Chimie et de Physique 1886, 6^{th} series (volume VIII), 502 [6];
Ba₁₀(Re₅)₆I₂ as described by G. Baud et al. in Materials Research Bulletin 1979, 14, 675 [7]; and
Sr₁₀(ReO₅)₆I₂ as described by M. S. Schriewer and W. Jeitschko in Journal of Solid State Chemistry 1993, 107, 1 [8].

However, it is preferred that the iodoapatite be obtained from a compound of formula (I) below:

M₃(XO₄)₂₋₂ₓ(PO₄)₂ₓ (I)

in which:
M is chosen from lead and cadmium,
X is chosen from vanadium and arsenic; and
x is equal to 0 or is greater than 0 while being less than 1,
   that is reacted, in the solid state, with an iodo compound such as a metal iodide, which is also in the solid state, the iodoapatites thus obtained proving, indeed, to exhibit stability and resistance properties that are particularly well suited to long-term storage.

This is the reason why the invention preferably comprises:

a) the mixing of a compound corresponding to the formula (I) above and of an iodo compound, these compounds being in the form of powders; then

b) the reactive sintering of the resulting mixture by the flash sintering technique.

In accordance with the invention, the iodo compound is advantageously a metal iodide, in particular lead iodide (PbI₂) or silver iodide (AgI), in which case the reaction of this compound with the compound of formula (I) is written:

PbI₂+3[M₃(XO₄)₂₋₂ₓ(PO₄)₂ₓ]→PbM₉(XO₄)₆₋₆ₓ(PO₄)₆ₓI₂,

or else

AgI+3[M₃(XO₄)₂₋₂ₓ(PO₄)₂ₓ]→AgM₉(XO₄)₆₋₆ₓ(PO₄)₆ₓI□,

the symbol □ representing a vacancy in the iodine site.

According to one particularly preferred arrangement of the invention, the compound of formula (I) is a lead vanadate or phosphovanadate of formula Pb₃(VO₄)₂₋₂ₓ(PO₄)₂ₓ in which x has the same meaning as before, whilst the iodo compound is lead iodide so that the iodoapatite corresponds to the formula (II) below: Pb₁₀(VO₄)₆₋₆ₓ(PO₄)₆ₓI₂ (II) in which x has the same meaning as before.

Preferably, x ranges from 0.1 to 0.75 and, better still, from 0.1 to 0.3, the most preferred value of x being 0.2.

In the latter case, the compound of formula (I) is Pb₃(VO₄)_{1.6}(PO₄)_{0.4} and results, via reaction with PbI₂, in the iodoapatite of formula Pb₁₀(VO₄)_{4.8}(PO₄)_{1.2}I₂.

In accordance with the invention, the reactive sintering is advantageously carried out at a temperature ranging from 400 to 500° C. and, better still, from 400 to 450° C., under a uniaxial pressure ranging from 15 to 150 MPa and, preferably, from 40 to 100 MPa.

The sintering time is, itself, preferably from 3 to 30 minutes and, better still, from 5 to 20 minutes starting from the moment when the sintering temperature is reached.

The compounds of formula (I) may be prepared by conventional processes.

Thus, for example, in the case where M represents Pb, the compounds of formula (I) in which x is equal to 0 may be obtained by solid/solid reaction of lead oxide and of vanadium pentoxide or of lead oxide and of HN₄H₂AsO₄, at a temperature of the order of 1000° C., whilst the compounds of formula (I) in which x is greater than 0 may be obtained by using a supplementary reactant, suitable for providing phosphate ions such as, for example, diammonium hydrogen phosphate.

In the case where M represents Cd, it is possible to use similar processes in which the lead oxide is replaced by cadmium oxide.

The compounds of formula (I) may also be reduced to powder by conventional milling processes of the type: mechanical milling, attrition milling, etc., the main being to obtain a powder of very fine particle size, ideally at most equal to 1 μm, in order to obtain an intimate contact between this powder and the powder of the iodo compound.

The invention has numerous advantages, namely:
it makes it possible to carry out the synthesis and densification of iodoapatites in a single step;
it makes it possible to carry out this synthesis and this densification at low enough temperatures and for short enough times to eliminate the risks of diffusion of the iodo compounds used as reactants and of volatilization of the iodine, and consequently to do away with the need to resort to an impermeable containment matrix;
it results, in addition, in iodoapatites of very high compaction being obtained, iodoapatites which have degrees of densification greater than 97% for reaction yields of 100% or close to this value and which therefore fulfil the criteria demanded as regards iodoapatites for the conditioning and storage of radioactive iodine in sites of deep geological layer type.

It therefore has a very particular advantage for conditioning and storing, in an apatite, the radioactive iodine present in the aqueous effluents from the reprocessing of spent nuclear fuels.

Therefore, in accordance with the invention, the iodine present in the iodoapatite is, preferably, radioactive iodine and, more particularly, iodine-129.

In this case, the iodo compound used as a reactant for the synthesis of the iodoapatite corresponds to the compound obtained during the elimination of the radioactive iodine from the aqueous effluents of spent nuclear fuel reprocessing plants, or is prepared directly from the latter.

The invention will be better understood in light of the remainder of the description which follows, which relates to an example for the preparation of an iodoapatite and which refers to the appended figures.

Of course, this remainder of the description is given only by way of illustration of the subject of the invention and by no means constitutes a limitation of this subject.

### BRIEF DESCRIPTION OF THE FIGURES

FIG. 1 schematically represents an example of a die that can be used for synthesizing and densifying an iodoapatite by the flash sintering technique.

FIG. 2 represents the X-ray diffraction diagram of an iodoapatite prepared in accordance with the invention.

### DETAILED DESCRIPTION OF ONE PARTICULAR EMBODIMENT

An iodoapatite of formula Pb₁₀(VO₄)_{4.8}(PO₄)_{1.2}I₂ is prepared in the following manner.

### Preparation of a Lead Phosphovanadate/Lead Iodide Mixture:

Firstly, lead phosphovanadate of composition Pb₃(VO₄)_{1.6}(PO₄)_{0.4} is prepared by calcining, in air, at a temperature of 1000° C. and for one hour, a stoichiometric mixture of lead oxide, of vanadium pentoxide and of diammonium hydrogen phosphate, previously homogenized via mechanical mixing.

The reaction is the following:

3PbO+0.8V₂O₅+0.4(NH₄)₂HPO₄→Pb₃(VO₄)_{1.6}(PO₄)_{0.4}+0.6H₂O+0.8NH₃.

The lead phosphovanadate thus obtained is then subjected to a first milling in ultrapure water (solid/water weight ratio=1) using a planetary mill equipped with jars and balls made of tungsten carbide. This milling is carried out for 1 hour, at a speed of 300 rpm.

Next, the lead phosphovanadate is subjected to a second attrition milling in water. This milling is carried out in a 750 cm³ jar made of zirconia with a powders/balls weight ratio equal to 1/9 (weight of the powder=100 g) and using, as a milling medium, a medium constituted of zirconia balls having a diameter of 1 and 2 mm in equal weight amounts. The rotational speed of the shaft is set at 450 rpm and the milling time at 4 hours. The suspension thus obtained is screened through a screen with a 125 μm cutoff threshold in order to separate the milling balls, then the suspension is dried in an oven until the water has completely evaporated and a powder is obtained.

Furthermore, lead iodide is prepared by precipitation in water, at ambient temperature and at a pH of 5 (obtained by addition of nitric acid), starting from sodium iodide and lead nitrate in an NaI/Pb(NO₃)₂ molar ratio equal to 2.

In this case, the reaction is the following:

2NaI_{(aq)}+Pb(NO₃)_{2(aq)}→PbI₂₍ₛ₎+2NaNO_{3(aq)}.

After filtration, the PbI₂ powder obtained is dried in an oven overnight.

Next, the lead phosphovanadate and the lead iodide are mixed in stoichiometric proportions (i.e. 3 mol of Pb₃(VO₄)_{1.6}(PO₄)_{0.4} per one mol of PbI₂) and this mixture is homogenized by attrition using operating conditions identical to those described above for the lead phosphovanadate alone except that the water is replaced with denatured ethanol.

### Reactive Sintering of the Lead Phosphovanadate/Lead Iodide Mixture:

The reactive sintering of the lead phosphovanadate/lead iodide mixture is carried out using a Sumitomo, Dr Sinter L model flash sintering machine which comprises:
a graphite die in which a sample of the lead phosphovanadate/lead iodide mixture is placed; and
two electrodes that are applied to the die and which are connected to a pulsed direct current generator.

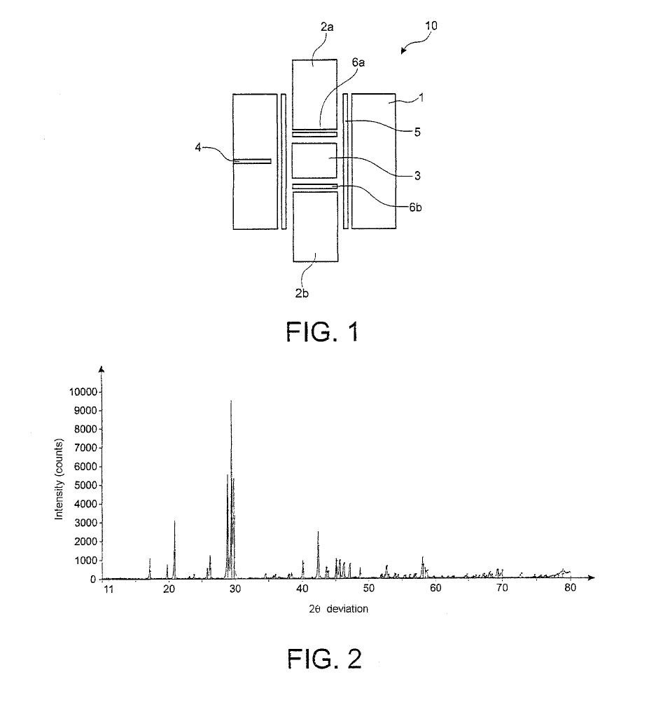

As can be seen in FIG. 1, which schematically represents the die (referenced 10 in this figure), the latter is composed of a hollow cylindrical die body 1 and of two symmetrical pistons, respectively 2a and 2b, which make it possible to transmit a uniaxial pressure to the sample 3 throughout the sintering process.

The die body 1 is pierced at its centre with a housing 4 for enabling the introduction of a thermocouple, the role of which is to measure and regulate the temperature. This thermocouple is then 2 mm away from the sample 3.

The die body 1 is lined with a graphite foil (Papyex®) which is intended to ensure a good conduction of the current along the whole die and to facilitate the demoulding of the sample at the end of the sintering process. Similarly, two discs of Papyex®, respectively 6a and 6b, are interposed between the sample 3 and the pistons 2a and 2b.

An external pressure of 70 MPa is applied at low temperature for 2 minutes before the start of the sintering, which is carried out under a dynamic primary vacuum. A current of 400 ampere approximately, in square wave form (pulses of 12 ms separated by a stop of 2 ms), is applied between the two electrodes.

Various tests are carried out by varying one of the following three operating conditions: sintering temperature, sintering time (compatabilized starting from the moment when the sintering temperature is reached) and external pressure, the latter being either maintained at 70 MPa, or lowered to 40 MPa at the end of the cold precompaction.

At the end of each test, the degree of densification of the sample is calculated from the ratio between the density presented by the samples (determined by hydrostatic weighing) and the theoretical density of the iodoapatite (7.117 g/cm³).

Table 1 presents the results obtained as a function of the operating conditions.

TABLE 1

| Sintering | Sintering | Heating | External | Degree of |
|---|---|---|---|---|
| temperature | time | rate | pressure | densification |
| (° C.) | (min) | (° C./min) | (MPa) | (%) |
| 400 | 5 | 50 | 40 | 97.5 |
| 400 | 20 | 50 | 40 | 97.8 |
| 400 | 5 | 50 | 70 | 97.9 |
| 450 | 5 | 50 | 40 | 98.0 |

This table shows that the use of the flash sintering technique makes it possible to obtain iodoapatites that have degrees of densification greater than 97% and, therefore, significantly higher than those obtained by the conventional sintering techniques of HUP or HIP type, this being for sintering temperatures a hundred or so degrees below those required by the conventional sintering techniques and for sintering times that are also substantially shorter (from 5 to 20 minutes versus 4 to 10 hours).

Furthermore, as is shown in FIG. 2, a characterization of the iodoapatites thus obtained by X-ray diffraction made it possible to confirm that these iodoapatites correspond well to the formula Pb₁₀(VO₄)_{4.8}(PO₄)_{1.2}I₂. Moreover, no secondary phase was identified, which confirms a synthesis yield of 100% (to within the detection limit, which is of the order of a few percent).

### REFERENCES CITED

[1] WO-A-96/18196
[2] C. Guy et al., C. R. Physique 2002, 3, 827-837
[3] E. R. Maddrell and P. K. Abraitis, Material Research Society Symposium Proceedings 2004, 807, 261-266
[4] F. Audubert et al., Solid State Ionics 1997, 95(1-2), 113-119
[5] M. UNO et al., Journal of Nuclear Materials 2001, 294(1-2), 119-122
[6] A. Ditte, Annales de Chimie et de Physique 1886, 6^{th} series (volume VIII), 502
[7] G. Baud et al., Materials Research Bulletin 1979, 14, 675
[8] M. S. Schriewer and W. Jeitschko, Journal of Solid State Chemistry 1993, 107, 1

1-11. (canceled)

12. A process for preparing an iodoapatite, the process comprising:
a) mixing an iodo compound and a compound of formula (I) below:
M₃(XO₄)₂₋₂ₓ(PO₄)₂ₓ (I)
in which:
M is chosen from lead or cadmium;
X is chosen from vanadium or arsenic; and
X is equal to 0 or is greater than 0 while being less than 1;
the iodo compound and the compound of formula (I) being in the form of powders; then
b) performing reactive sintering of the mixture thus obtained using the flash sintering technique.

13. The process of claim 12, in which the iodo compound is one of lead iodide (PbI₂) and silver iodide (AgI).

14. The process of claim 12, in which the compound of formula (I) is a lead vanadate or phosphovanadate of formula:
Pb₃(VO₄)₂₋₂ₓ(PO₄)₂ₓ
in which x is equal to 0 or is greater than 0 while being less than 1;
wherein the iodo compound is lead iodide so that the iodoapatite corresponds to the formula (II) below:
Pb₁₀(VO₄)₆₋₆ₓ(PO₄)₆ₓI₂ (II)
in which x is equal to 0 or is greater than 0 while being less than 1.

15. The process of claim 12, in which x ranges from 0.1 to 0.75.

16. The process of claim 12, in which x is equal to 0.2.

17. The process of claim 12, in which the reactive sintering is carried out at a temperature ranging from 400 to 500° C.

18. The process of claim 12, in which the reactive sintering is carried out under a uniaxial pressure ranging from 15 to 150 MPa.

19. The process of claim 12, in which the duration of the reactive sintering is from 3 to 30 minutes starting from the moment when the sintering temperature is attained.

20. The process of claim 12, in which the iodine present in the iodoapatite is radioactive iodine.

21. The process of claim 20, in which the radioactive iodine is iodine-129.

22. The process of claim 15, in which x ranges from 0.1 to 0.3.

23. The process of claim 17, in which the reactive sintering is carried out at a temperature ranging from 400 to 450° C.

24. The process of claim 18, in which the reactive sintering is carried out under a uniaxial pressure ranging from 40 to 100 MPa.

25. The process of claim 19, in which the duration of the reactive sintering is from 5 to 20 minutes.
